(19) United States
(12) Patent Application Publication
(10) Pub. No.: US 2005/0080660 A1
(43) Pub. Date: Apr. 14, 2005

(54) System and method for optimizing equipment schedules

(76) Inventors: Anura H. deSilva, Bethesda, MD (US); Jonathan F. Bard, Austin, TX (US); Robert Carignan, Quebec City (CA); Xiangtong Qi, Kowloon (HK); Xinhui Zhang, Dayton, OH (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/929,771

(22) Filed: Aug. 31, 2004

Related U.S. Application Data
(60) Provisional application No. 60/507,504, filed on Oct. 2, 2003.

(51) Int. Cl. G06F 17/60

(52) U.S. Cl. 705/9

(57) ABSTRACT

Embodiments of the invention provide a system and method for developing and optimizing equipment operating schedules. Embodiments also describe the relationship between equipment scheduling and related objectives, such as staff scheduling. In one respect, embodiments of the invention consider staffing constraints in developing equipment schedules. In another respect, embodiments of the invention provide outputs from an equipment scheduling tool that can facilitate improved labor schedules, for example with respect to equipment operators and/or material handlers.

### CROSS-REFERENCE TO RELATED APPLICATIONS

This application claims priority under 35 U.S.C. § 119(e) to U.S. Provisional Application No. 60/507,504, filed Oct. 2^{nd}, 2003, the entire content of which is hereby incorporated by reference.

### BACKGROUND

The invention relates generally to the field of operations management. More specifically, but not by limitation, the invention relates to a system and method for developing and optimizing equipment operating schedules.

Many manufacturing and service organizations utilize equipment in producing goods or in delivering services. Often, the delivery of a good or service requires the execution of processes on multiple pieces of equipment, each having unique functional capabilities. A service-industry example is a mail Processing & Distribution Center (P&DC).

FIG. 1 is a process flow diagram for letters in a P&DC. Mail arrives at the P&DC's receiving area and is broken down into one of several pre-defined groups based on origination, physical size, quality of address, and degree of previous processing. Each group has a different composition and follows a unique route (series of operations) through the facility. The major groups are local collection mail 105 gathered from the street boxes served by the P&DC, and incoming mail 110 partially processed at another P&DC and dispatched to the local P&DC for distribution. Local collection mail 105 and incoming mail 110 is processed through operations 115 enroute to a Delivery Unit (DU) 120 or 130, or to other P&DCs 125.

Operations 115 utilize five types of equipment for mail processing: an Advanced Facer-Canceller System (AFCS); a Multi-Line Optical Character Reader (MLOCR); a Remote Encoding Center (REC), a Remote Barcode Sorter (RBCS)(not shown); and a Delivery Barcode Sorter (DBCS). AFCSs are used to find, face, and cancel stamps, as well as to filter out some handwritten letters, printed envelopes and pre-barcoded letters. MLOCRs are capable of reading a machine-printed address, accessing a regional database, and spraying the corresponding barcode on the envelope. Most mail is sprayed with a 9- or 11-digit barcode. The RBCSs are designed to assign barcodes to mail pieces that are unreadable by an MLOCR. When such an envelope passes an MLOCR, it is tagged with a florescent ID and the image of the address field is lifted. At this point, the envelope and the image follow two parallel routes. While the envelope is waiting to be transferred to a RBCS, the image is transmitted to a REC where operators key in the relevant address information and the system subsequently finds the 11-digit code in a national directory. As the mail piece reaches a RBCS, it is re-identified by its ID and sprayed with the barcode in the remote video center's database. The DBCSs are used to read the barcode on the envelope and to divert the mail pieces to separate bins. A bin contains letters that go to the same geographic area, i.e., cities, post offices, firms or apartments, depending on the level of sorting. Operations 115 are illustrated with arrows to represent flows between individual operations 115.

Human equipment operators (or clerks) are required to control, monitor, or otherwise assist the equipment-based operations 115 during processing. In addition, human material handlers (or mail handlers) are needed to transport work-in-process (WIP) between operations 105, 110, 115, 120, 125, and 130. Thus, for pre-existing P&DCs with fixed equipment assets, the importance of equipment scheduling is in managing labor costs associated with the equipment-based operations. Similar problems exist in other service and manufacturing organizations.

Known systems and methods for equipment scheduling, however, do not adequately consider staffing constraints in arriving at an equipment scheduling solution. In addition, it is commonplace for staff scheduling to be performed separately from equipment scheduling and without the benefit of equipment scheduling information. What is needed is an improved system and method for optimizing equipment schedules and for facilitating the optimization of staffing plans for labor associated with operating the equipment and/or handling WIP.

### SUMMARY OF THE INVENTION

Embodiments of the invention provide a system and method for developing and optimizing equipment operating schedules. Embodiments also describe the relationship between equipment scheduling and related objectives, such as staff scheduling. In one respect, embodiments of the invention consider staffing constraints in developing equipment schedules. In another respect, embodiments of the invention provide outputs from an equipment scheduling tool that can facilitate improved labor schedules, for example with respect to equipment operators and/or material handlers.

Embodiments of the invention provide a method for planning, including: generating an equipment scheduling solution for equipment used to process items, the generating the equipment scheduling solution including minimizing an amount of ending inventory of the items in a scheduling time period; generating staffing requirements for personnel during the scheduling time period based on the equipment scheduling solution; and generating a staffing solution for the scheduling time period based on the staffing requirements.

Embodiments of the invention provide a method for planning, including: receiving equipment scheduling data and constraints for equipment used to process items; creating a first equipment scheduling solution that minimizes inventory of the items remaining unprocessed at the end of a scheduling period; relaxing an ending inventory by a first parameter, the relaxing the ending inventory raising an ending inventory constraint value for evaluating subsequent alternative equipment scheduling solutions; and creating a second equipment scheduling solution based on the first equipment scheduling solution and the ending inventory constraint that minimizes a number of shifts that a piece of equipment is scheduled during the scheduling period.

Embodiments of the invention provide a method for generating material handler staffing requirements, including: modeling a plurality of process operations, each of the plurality of process operations having an input buffer, a processing capability, and at least one output buffer; calculating inventory for each of the plurality of process operations during a time period, the calculating including: decrementing inventory in the associated input buffer; and incrementing inventory in the associated at least one output buffer, the decrementing and incrementing based on the associated processing capability; and determining material handler requirements based on inventory in at least one of the associated input buffer and the associated at least one output buffer at the end of the time period.

Embodiments of the invention provide a machine-readable medium having instructions stored thereon for execution by a processor to perform one or more of the methods described above.

Embodiments of the invention provide a planning system including: an equipment scheduling engine, the equipment scheduling engine configured to output an equipment scheduling solution based on a minimized ending inventory of items processed by the equipment; a simulation model, the simulation model configured to validate the equipment scheduling solution and further configured to generate material handler requirements; and an interface to a staff scheduler.

The features and advantages of the invention will become apparent from the following drawings and detailed description.

### BRIEF DESCRIPTION OF THE DRAWINGS

Embodiments of the invention are described with reference to the following drawings, wherein:

FIG. 1 is a process flow diagram for a Processing & Distribution Center (P&DC), according to the related art;

FIG. 2 is a process flow diagram for equipment and staff scheduling, according to an embodiment of the invention;

FIG. 3 is a resource map illustrating a reduction in the number of shifts, according to an embodiment of the invention;

FIG. 4 is a resource map illustrating a reduction in the number of operation startups, according to an embodiment of the invention;

FIG. 5 is a resource map illustrating a reduction in the number of operation startups, according to an embodiment of the invention;

FIG. 6 is a resource map illustrating the reduction of a gap between operations, according to an embodiment of the invention;

FIG. 7 is a process flow diagram for generating an equipment scheduling solution, according to an embodiment of the invention;

FIG. 8 is a process flow diagram for generating an equipment scheduling solution, according to an embodiment of the invention;

FIG. 9 is a block diagram of a model for generating material handler staffing requirements, according to an embodiment of the invention;

FIG. 10 is a process flow diagram for generating material handler requirements, according to an embodiment of the invention;

FIG. 11 is a process flow diagram for determining material handler requirements, according to an embodiment of the invention; and

FIG. 12 is a block diagram of a functional architecture for optimizing equipment and staffing schedules, according to an embodiment of the invention.

### DETAILED DESCRIPTION

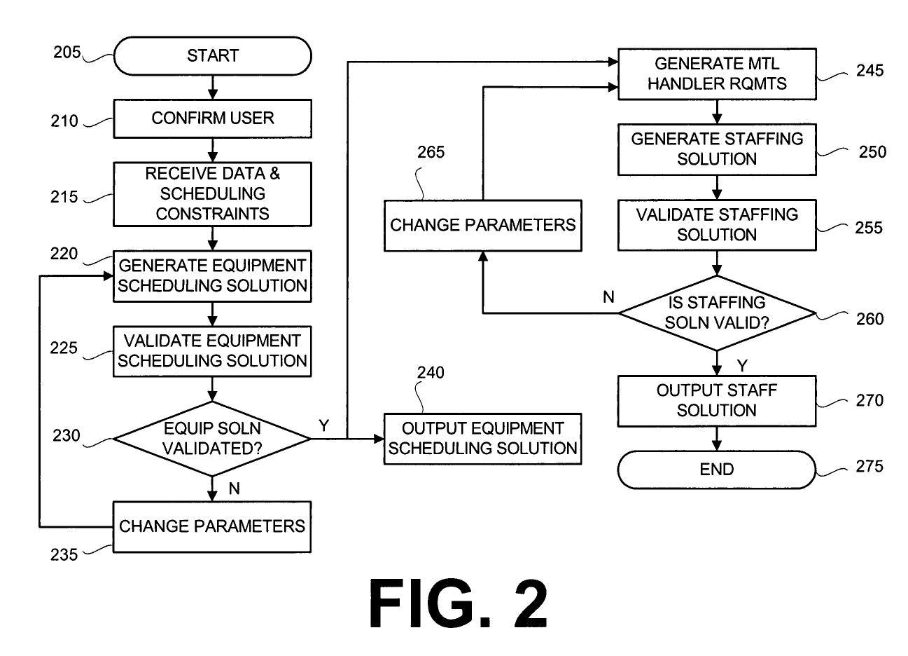

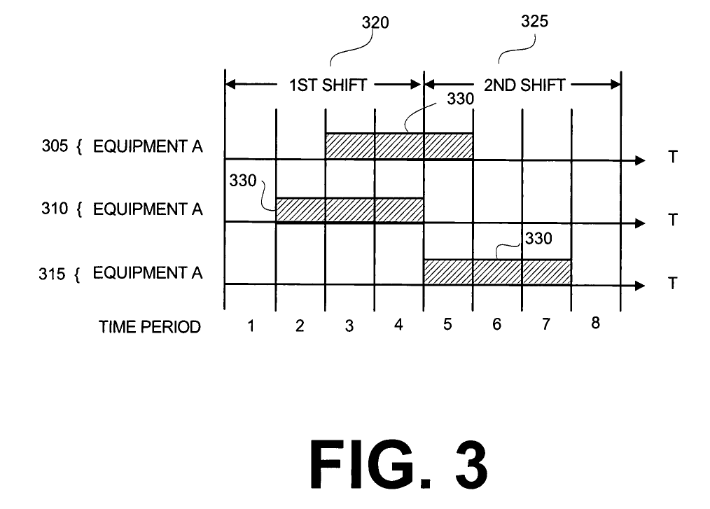

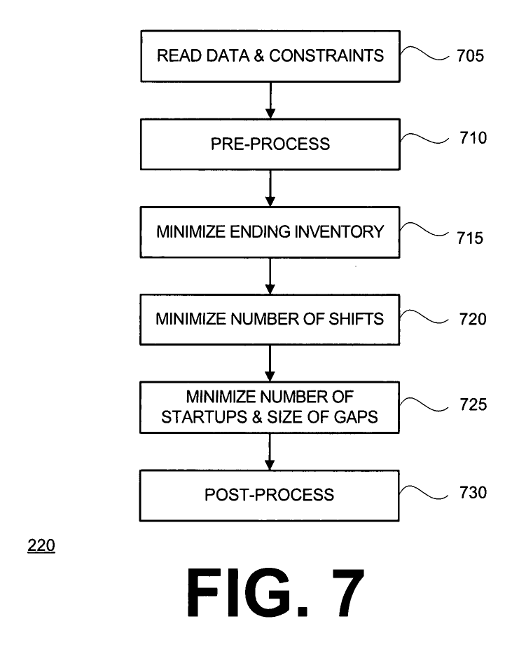

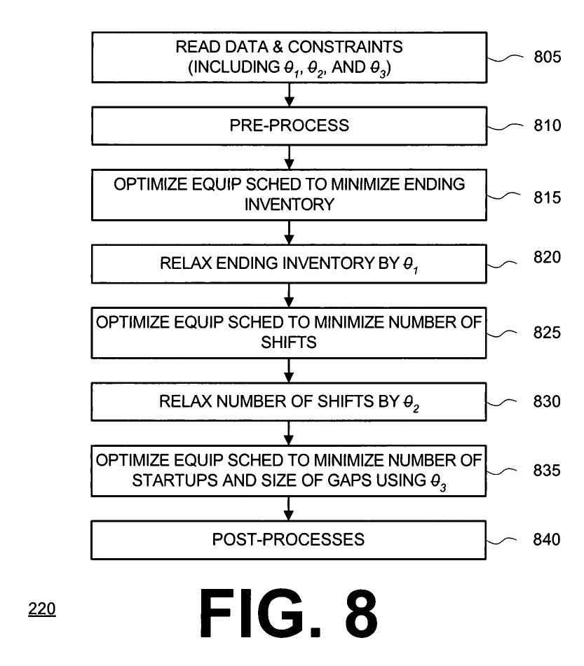

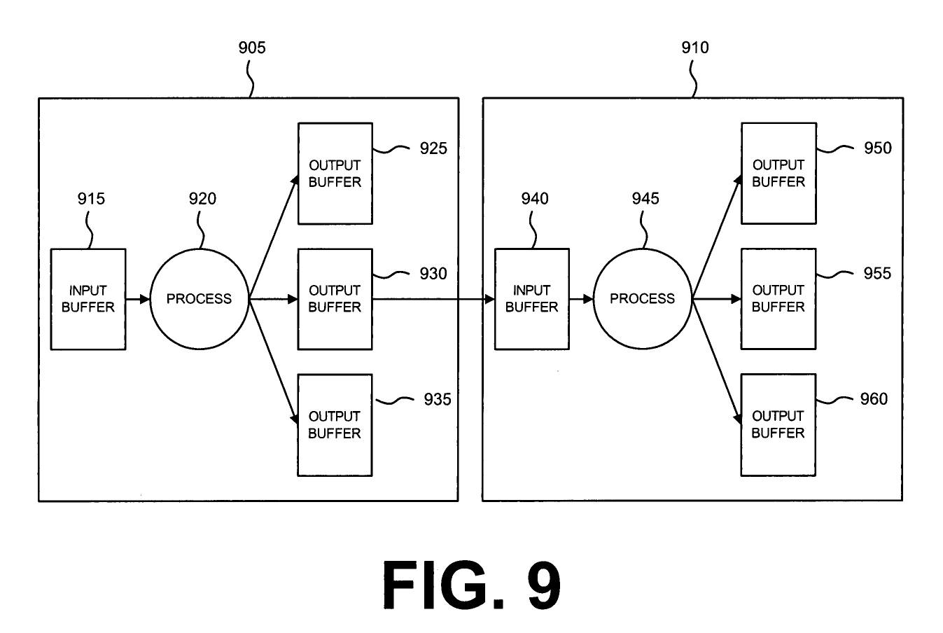

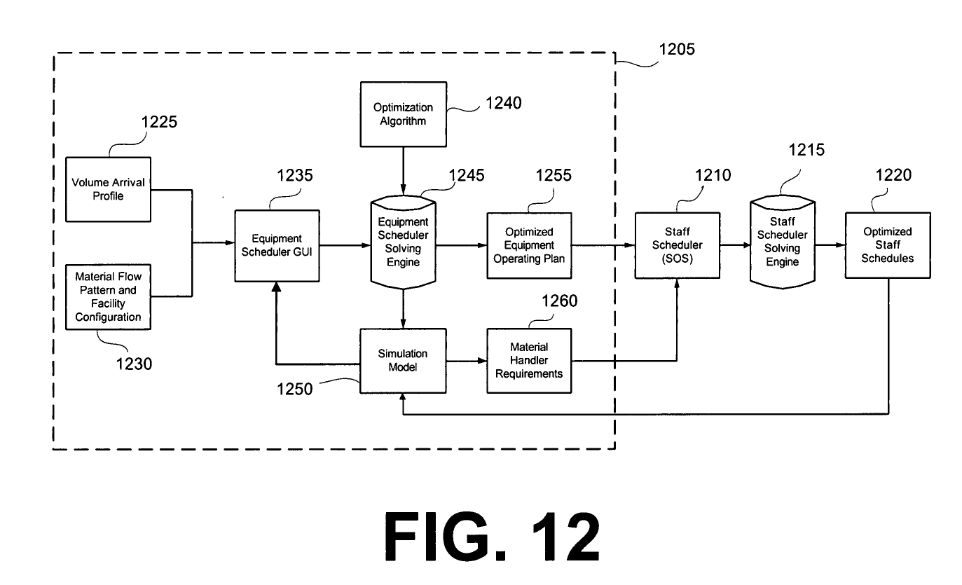

Embodiments of the invention are first described with reference to a high-level process flow diagram in FIG. 2, illustrating the relationship between equipment scheduling and staff scheduling. Resource maps are provided in FIGS. 3-6 to illustrate various objectives of the equipment scheduling component, and embodiments of equipment scheduling methods are disclosed with reference to process flow diagrams in FIGS. 7 and 8. Methods for generating material handler requirements are described with reference to FIGS. 9-11. Finally, a block diagram of a functional architecture is presented in FIG. 12 for performing one or more of the processes described herein. As used herein, “minimize,” “minimizing,” “minimized,” “optimize,” “optimizing,” and “optimized” are relative terms, and are not absolute terms. We begin with an overview of related processes.

Overview

FIG. 2 is a process flow diagram for equipment and staff scheduling, according to an embodiment of the invention. As shown therein, the process begins in step 205, then confirms, for example with reference to a predetermined database, that a user is authorized to use the system in step 210. In a step not shown, the process may return an error message to the user when the user is not authorized to use the system.

The process receives input data and equipment scheduling constraints in step 215. In the case of equipment scheduling in a mail P&DC for example, input data can include items such as starting mail inventory, volume of arriving mail, distribution of arriving mail over the planning period, a list of operations to be performed on the mail, clearance times, the throughput for each operation, the configuration of the facility (including the machine groups and the number of machines in each group), equipment throughput rates, and required number of operators per machine. Constraints may include factors such as predetermined maintenance schedules, limits on mail flows, time windows during which operations can be performed, the need to set up a machine for each operation, and work-in-process inventory accumulation. The distinction between input data and constraints is that input data are required to initialize and drive the system, whereas constraints govern the flow of material through the system, determining its routing, processing sequence, staging, and final dispatch.

The input data and constraints are then used in execution of equipment scheduling step 220. The output of step 220 is an optimized equipment schedule providing startup and clearance times, or equivalent information (such as startup and duration, or active time periods) for each piece of equipment in the facility. Embodiments of step 220 are described below with reference to FIGS. 7 and 8.

In the illustrated embodiment, the process then validates the equipment scheduling solution in step 225. Validation step 225 may include, for example, running a simulation of mail processing based on the equipment schedules generated in step 220, and comparing the leftover mail from the equipment scheduling solution derived in step 220 to the leftover mail indicated by the simulation in step 225. In conditional step 230, the process determines whether the equipment schedule generated in step 220 has been validated in step 225. If step 220 is determined in the negative, then the process may change one or more scheduling constraints or other parameters in step 235, then return to equipment scheduling step 220. Otherwise, the process advances to output equipment schedules in step 240 and generates material handler requirements in step 245. An embodiment of step 245 is described below with reference to FIGS. 9-11. Validation step 225 and conditional step 230 may be combined into a single process step.

In the illustrated embodiment, the requirements provided in step 245 are then used to generate a staffing solution for material handlers in step 250. The staffing solution generated in step 250 may be constrained by labor laws, union agreements, and other factors. The staffing solution generated in step 250 is then validated in step 255. Validation step 255 may include for example running a process simulation of material handling based on the staffing solution generated in step 250. The staffing solution is valid if, according to the simulation in validation step 255, the amount of unprocessed mail at the end of the scheduling time period is the same or within a predetermined range of the amount of unprocessed mail generated in step 220. If it is determined in conditional step 260 that the staffing solution is valid, then the staffing solution is output in step 270 and the process terminates in step 275; otherwise, the process adjusts staffing constraints or other parameters in step 265, then returns to step 245 to generate material handler requirements. Validation step 255 and conditional step 260 may be combined into a single process step.

Alternative flows to the one illustrated in FIG. 2 are possible. For example, validation steps 225 and/or 255 (and/or associated conditional steps 230 and 260, respectively) are optional. In an alternative embodiment, after changing parameters in step 265, the process may return to step 250 to generate the staffing solution (instead of returning to step 245 to generate the material handler requirements). Also, it may be useful to execute validation step 225 in a stand-alone or offline mode to perform parametric (or “what if”) analysis. For instance, an operator could investigate the robustness of the equipment scheduler based on changes to one or more constraints such as throughput rates, machine failure rates, maintenance schedules, mail arrival profiles, or other factors. Where used, validations steps 225 and/or 255 may be automatically or manually performed. The equipment scheduler may also be used without any interface to a staff scheduler.

Equipment Scheduling Objectives

Embodiments of scheduling step 220 implement one or more of the following equipment scheduling objectives: (1) minimizing the ending inventory in a given scheduling period; (2) minimizing the number of shifts required to run the equipment; (3) minimizing the number of process startups in a given scheduling period; and (4) minimizing the weighted sum of the number of machine periods used in a given time period (a/k/a minimizing the gap). For mail sorting operations, the inventory is the mail in the facility, and the given time period is typically a single day. Each of the foregoing objectives is further described below in this context.

The first equipment scheduling objective is to minimize the ending inventory. Ideally, all mail arriving at a P&DC facility would be cleared in a single day. Due to capacity limitations of the equipment and other factors, however, this may not be possible, so some of the mail may have to be held over to the next day.

The second objective, minimizing the number of shifts required per day, is used as an approximation of labor cost. A shift is defined as a set of continuous time periods within a day, and is characterized by a start time and a length. In an exemplary P&DC, a full-time shift may span 8½ hours including a half-hour lunch break and part time shifts may span anywhere from 4 to 8½ hours. As a simplification, it is possible to only consider full-time shifts and treat them as continuous working periods of 8 hours with predetermined start times and no lunch breaks. Other shift lengths may also be used (for example 10 hours shifts). Because different skills are required to operate the equipment, it is necessary to associate shifts with machine groups.

FIG. 3 is a resource map illustrating a reduction in the number of shifts, according to an embodiment of the invention. As shown therein, three alternative schedules 305, 310, and 315 are provided for performing operation 330. In meeting the second scheduling objective, the system would favor scheduling cases 310 or 315 over case 305, because case 310 only provides staff demand for the 1^{st} shift 320, and case 315 only provides demand for the 2^{nd} shift 325.

The third objective, minimizing the number of process startups (when processing begins on each piece of equipment) has two benefits. First, it reduces the number of times that the machines are switched on and off, and second, it reduces the number of set-ups required to configure a machine for a different operation. The result should be a smoother and more continuous schedule.

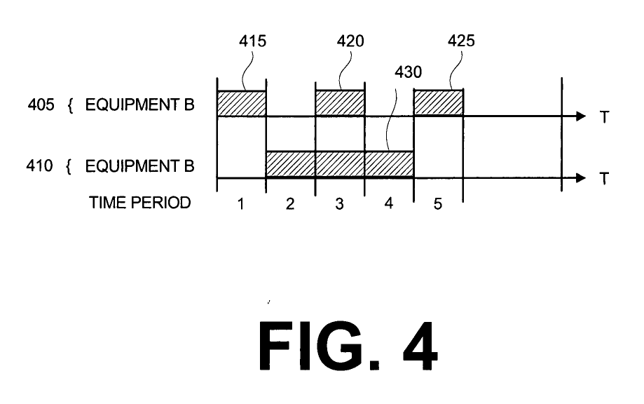

FIG. 4 is a resource map illustrating a reduction in the number of operation startups, according to an embodiment of the invention. As shown therein, case 405 schedules three operations 415, 420 and 425, and case 410 schedules a single operation 430. In FIG. 4, operations 415, 420, 425 and 410 are all similar in function, but different in start time and/or duration. In meeting the third scheduling objective, case 410 would be favored over case 405, because case 410 has only a single process operation startup compared to three startups in case 405.

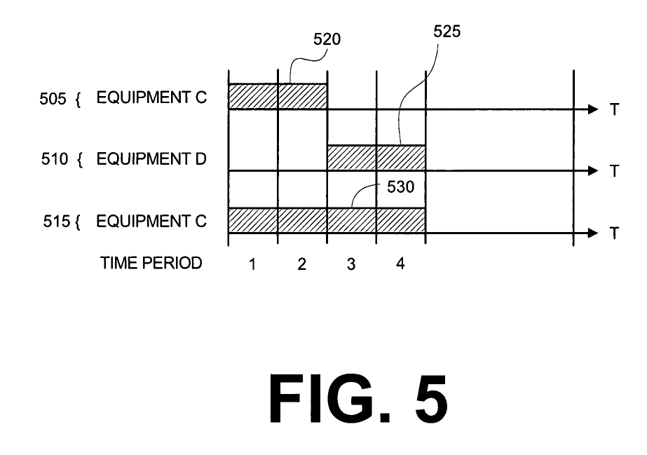

FIG. 5 is a resource map illustrating a reduction in the number of operation startups, according to an embodiment of the invention. As shown therein, case 505 schedules process operation 520 on equipment C, case 510 schedules process operation 525 on equipment D, and case 515 schedules process operation 530 on equipment C. In FIG. 5, equipment C and equipment D are configured to perform the same function. In furtherance of the third objective, the process would favor schedule 515 over the combination of schedules 505 and 510, where the type and capacity of process operation 530 is equivalent to the sum of process operations 520 and 525.

The fourth objective is similar to the third, except that processing in earlier periods is penalized more than processing in later periods. This has the effect of pushing an operation to as late in the operation window as possible, as well as implicitly shortening the working intervals. This is advantageous because processes scheduled later in the day are more likely to be running at capacity than processes scheduled earlier in the day.

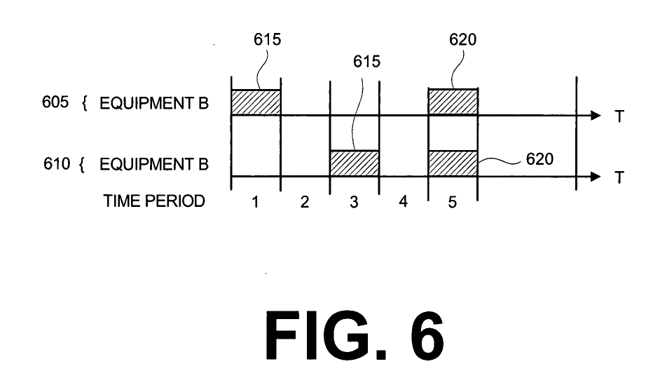

FIG. 6 is a resource map illustrating the reduction of a gap between operations, according to an embodiment of the invention. As shown therein case 605 schedules process operations 615 and 620 in time periods 1 and 5, respectively; case 610 schedules process operations 615 and 620 in periods 3 and 5, respectively. In satisfying the fourth objective, the system favors case 610 because process operation 615 is scheduled later in time, and is therefore more likely to be running at full capacity. Case 610 has also reduced the gap between process operations 615 and 620, likely resulting in more efficient labor utilization. Objectives other than the four objectives described above may be used in the alternative or in combination with any one or more of the objectives described above, according to design choice. For example, rather than assuming that the number of machines in a facility is fixed, this number may be treated as a variable. Possible objectives, then, might be (1) to minimize a weighted combination of the numbers of machines needed to process the mail and (2) to minimize the net present value associated with purchasing the required complement of machines and operating them over their useful life. If more than one type or model of machine were available to perform a particular operation, then selecting the optimal type or model to purchase could be included in these objectives.

Equipment Scheduling Detail

FIG. 7 is a process flow diagram for generating an equipment scheduling solution, according to an embodiment of the invention. In other words, FIG. 7 represents an embodiment of process step 220. The illustrated process executes the foregoing objectives sequentially. As shown In FIG. 7, the process begins by reading data and constraints in step 705. Then, in pre-processing step 710, any number of restrictions implied by the physical flow or user input are exercised to limit the number of possible solutions. For example, start times might be delayed based on the mail arrival profile, process operation end times might be set based on clearance needs, and specified process flows can be used to eliminate alternative routings. Next, the process generates an optimized equipment schedule by minimizing ending inventory in step 715, minimizing the number of shifts in step 720, and minimizing the number of startups and size of gaps in step 725. Note that in the illustrated embodiment, satisfaction of the third and fourth scheduling objectives are executed concurrently.

The output of step 725 is an equipment scheduling solution that indicates a startup and end time, or equivalent information (such as startup time and duration, or active time periods) for each operation, together with an integer value for the number of pieces of equipment that will perform that same operation. In post-processing step 730, the output from step 725 is converted to startup and end time, or equivalent information (such as startup time and duration, or active time periods) for each piece of equipment in the facility.

Variations of the process shown in FIG. 7 are possible. For example, the pre-processing step 710, included to allow for an initial bounding of the solution, is optional. In addition, minimizing the number of startups and minimizing the size of gaps could be performed separately. Moreover, the sequence of operations, illustrated in FIG. 7 in order of importance, could be reordered according to user requirements. Further, one embodiment of the invention determines an optimum equipment schedule by considering all objectives simultaneously. In alternative embodiments, fewer than all objectives may be used, or other objectives may be substituted for those shown in FIG. 7 and described above.

FIG. 8 is a process flow diagram for generating an equipment scheduling solution, according to an embodiment of the invention. FIG. 8 introduces three terms:

θ₁ relaxation parameter for unprocessed mail, 0≦θ₁;

θ₂ relaxation parameter for shifts, 0≦θ₂; and

θ₃ smoothing parameter, 0≦θ₃≦1;

where θ₁ and θ₂ may be percentages, and θ₃ may be a fractional value. θ₁ is related to the first scheduling objective, θ₂ is related to the second scheduling objective, and θ₃ is related to the third and fourth scheduling objectives.

The process in FIG. 8 begins by reading input data and constraints in step 805, including user-definable parameters θ₁, θ₂, and θ₃. The process then advances to pre-processing step 810, where any number of restrictions implied by the physical flow or user input are exercised to limit the number of possible solutions. For example, start times might be delayed based on the mail arrival profile, process operation end times might be set based on clearance needs, and specified process flows can be used to eliminate alternative routings.

The process then determines an optimal equipment schedule that minimizes the amount of ending inventory in step 815, in accordance with the first scheduling objective. Because no other scheduling solution can result in a smaller amount of ending inventory, and because other scheduling objectives must also be considered, the amount of ending inventory calculated in step 815 is relaxed by parameter θ₁ in step 820. For example, if the ending inventory calculated in step 815 is 1,000 pieces of mail, and relaxation parameter θ₁ is 10%, then the allowable ending inventory is adjusted to 1,100 pieces in step 820.

Next, the process updates the optimal equipment schedule by minimizing the number of shifts, while ensuring that the ending inventory is no greater than the relaxed amount, in step 825. Then, because no other scheduling solution can result in a smaller number of shifts, and because other objectives still must also be considered, the number of shifts calculated in step 825 is relaxed by parameter θ₂ in step 830.

In step 835, the equipment schedule is further updated to minimize a linear combination of the number of machine startups and the weighted sum of working periods over all operations. The parameter used for step 835 is θ₃, which can be set in the range of 0 and 1. For values close to θ₁ the emphasis is on smoothing the schedule, that is, minimizing the number of times the machines switch operations or are turned on and off. When θ₃ is close to 1, the emphasis is on compressing the schedule (minimizing the gaps).

The output of step 835 is an equipment scheduling solution that indicates a startup and end time, or equivalent information (such as startup time and duration, or active time periods) for each operation, together with an integer value for the number of pieces of equipment that will perform that same operation. In post-processing step 840, the output from step 835 is converted to startup and end time, or equivalent information (such as startup time and duration, or active time periods) for each piece of equipment in the facility.

The foregoing method thus determines an optimal equipment scheduling process by considering each of several predetermined objectives.

Variations of the process shown in FIG. 8 are possible. For example, the pre-processing step 810, included to allow for an initial bounding of the solution, is optional. In addition, minimizing the number of startups and minimizing the size of gaps could be performed separately, instead of together as illustrated in step 835. Moreover, the sequence of operations could be reordered according to user requirements, and different objectives could be used.

Advantageously, the equipment scheduling process 220, embodiments of which are described above with reference to FIGS. 7 and 8, may also be used for determining the type and quantity of machines that are required for a new P&DC or other processing operation. Likewise, equipment scheduling process 220 may be used to evaluate changes in the type and quantity of machines in existing P&DCs or other processing operations.

As described with reference to FIG. 2 above, outputs from equipment scheduling processes may be used to inform a staff scheduling utility.

Generating Material Handler Requirements

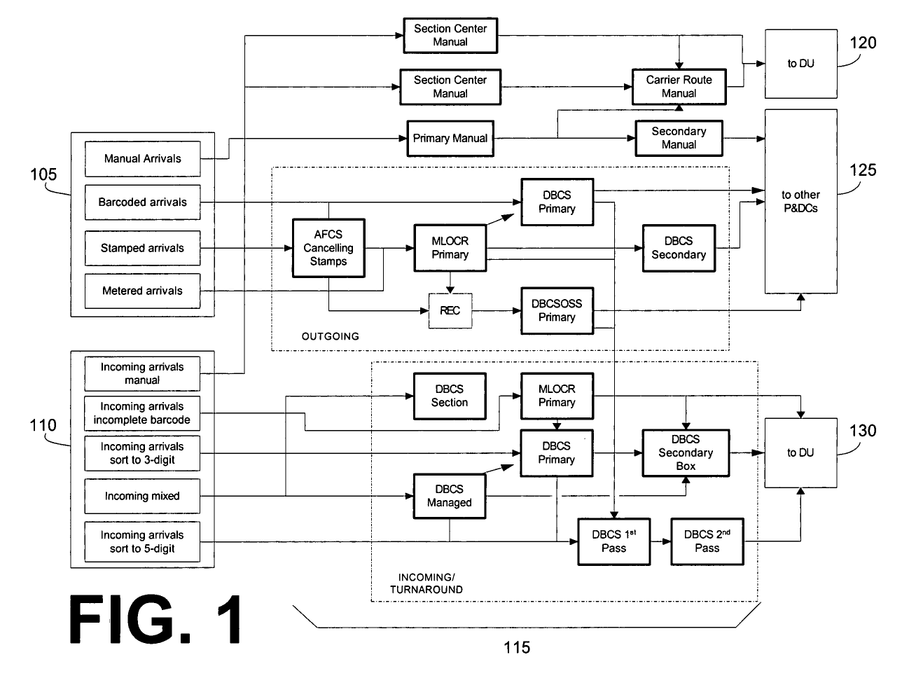

FIG. 9 is a block diagram of a model for generating material handler staffing requirements, according to an embodiment of the invention. FIG. 9 illustrates two operations 905 and 910, which could be, for example, representative of sequential operations illustrated in FIG. 1.

In this context, material handlers refers to staff that transport and otherwise handle mail between operations for example as between operations 105 and 115, as between operations 110 and 115, as between operations 115 themselves, or as between operations 115 and any of operations 120, 125, or 130. For instance, material handlers could be associated with a mail preparation operation, a presort operation, a pouching/sacking operation, and opening unit operation, a sleeving, covering, and/or strapping operation, a manual sack sorting operation, a supporting tray management operation, a supporting automated dispatch equipment operation, and air mail scanning and/or tagging operation, or a powered equipment operation, as might be associated with a mail P&DC.

Operation 905 includes an input buffer 915 that feeds a process 920. The output of process 920 feeds output buffers 925, 930, and 935. Operation 910 includes an input buffer 940 that feeds a process 945. The output of process 945 feeds output buffers 950, 955, and 960. Output buffer 930 feeds input buffer 940; output buffers 925 and 935 feed other operations (not shown).

Input buffers 915 and 940 represent to-be-processed inventory, for example the amount of mail waiting to be processed by processes 920 and 945, respectively. Processes 920 and 945 are associated with a processing capability, expressed in terms of an amount of mail or other material that can be processed during a predetermined time interval (e.g., one minute). The processing capability may take into account inefficiencies associated with equipment setup and/or clearance times. Output buffers 925, 930, and 935 represent to-be-picked-up inventory resulting from process 920, and output buffers 950, 955, and 960 represent to-be-picked-up inventory resulting from process 945.

In the illustrated embodiment, output buffer 930 is an upstream buffer with respect to input buffer 940, and input buffer 940 is a downstream buffer with respect to output buffer 930.

Variations to the model illustrated in FIG. 9 is possible. For example, in the general case, more than two operations may be modeled together. Moreover, any one or more of the modeled operations may have less, or more, than three output buffers.

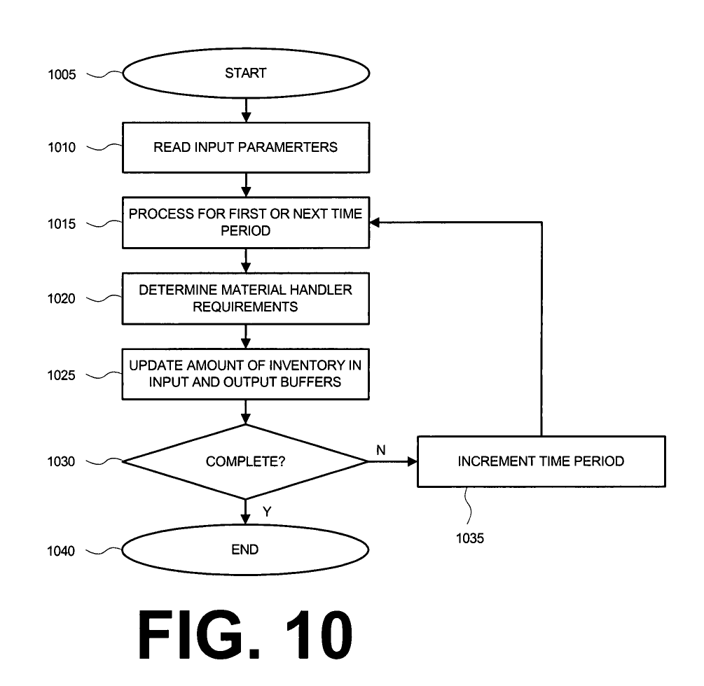

FIG. 10 is a process flow diagram for generating material handler requirements, according to an embodiment of the invention. FIG. 10 illustrates an embodiment of step 245, and could be used to generate material handling requirements, for instance, between output buffer 930 and input buffer 940.

As shown in FIG. 10, the process begins in step 1005 and then advances to step 1010 to read input parameters provided, for example, by equipment scheduling step 220. The input parameters read in step 1010 may include, for instance, volume arrival profiles, processing capability values, mail flow matrix (or other description of the relationship between operations), equipment operating schedules, and mail handler capacity (e.g., the volume of mail that a single mail handler is able to move between two predetermined operations in a predetermined interval of time).

The process is then promoted to step 1015 to process for a first or next time period. For example, in step 1015 mail is moved from input buffer 915 to one or more output buffers 925, 930 and 935 based on the capability of process 920. Thus, if input buffer 915 has 10,000 pieces of mail at the start of the current time period, if the data read in step 1010 indicates that the capability of process 920 is 100 pieces of mail/minute, and if the equipment schedule read in step 1010 indicates that process 920 is active for the current time period, and if the current time period has a duration of five minutes, then a total of 500 pieces of mail would be shifted from input buffer 915 to one or more output buffers 925, 930 and 935.

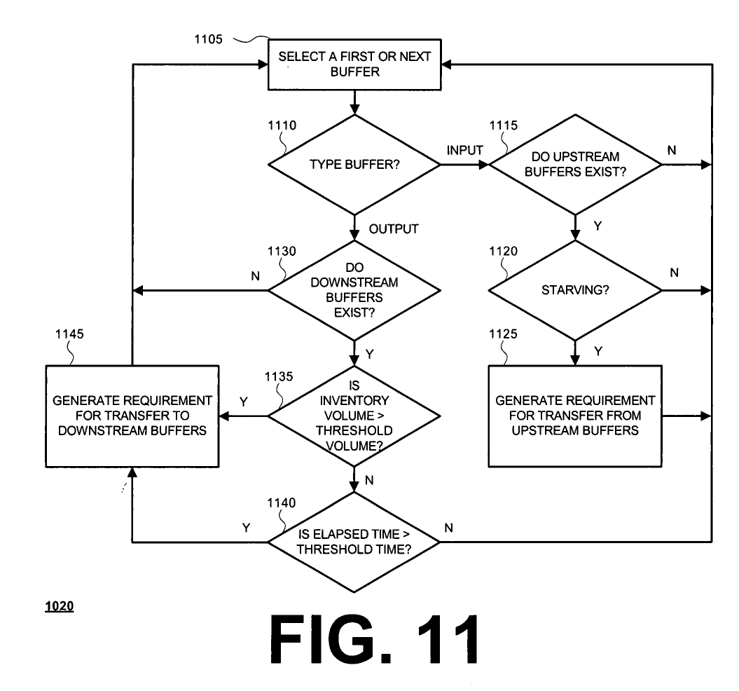

Next, material handler requirements are determined for the current time period in step 1020. One embodiment of step 1020 is described below with reference to FIG. 11.

Inventory amounts are then updated in the input and output buffers in step 1025. Next, in conditional step 1030, it is determined whether the material handler requirements generation step 245 is complete. Step 245 may be complete, for example, where no further equipment scheduling data is available. If the result of conditional step 1030 is negative, then the time period is incremented in step 1035 and the process returns to step 1015. If the result of conditional step 1030 is in the affirmative, then the process terminates in step 1040.

FIG. 11 is a process flow diagram for determining material handler requirements, according to an embodiment of the invention. FIG. 11 illustrates an embodiment of step 1020, for a given time period. As shown in FIG. 11, the process begins by selecting a first or next buffer in step 1105. For example, the selection could be any one of buffers 925, 930, 935, 950, 955, or 960. In conditional step 1110, the process determines the type of buffer, for example whether the selected buffer is an input buffer or an output buffer.

If it is determined in conditional step 1110 that the buffer is an input buffer, then the process advances to conditional step 1115 to determine whether one or more upstream buffers exist. Where the result of conditional step 1115 is in the negative, for example the case of input buffer 915 which has no upstream buffer, the process returns to step 1105 without generating a material handling requirement. Where the result of conditional step 1115 is in the affirmative, the process advances to conditional step 1120 to determine whether the selected process is starving. For instance, if the selected input buffer is input buffer 940, and if input buffer 940 has been depleted below a predetermined threshold, then the result of conditional step 1120 would be in the affirmative, generating a material handling requirement in step 1125 for the transport of mail from upstream output buffer 930 to input buffer 940. Where the result of conditional step 1120 is in the negative, the process returns to step 1105 without generating a material handling requirement. Conditional step 1120 may be referred to as a downstream threshold rule.

If it is determined in conditional step 1110 that the buffer is an output buffer, then the process advances to conditional step 1130 to determine whether one or more downstream buffers exist. Where the result of conditional step 1115 is in the negative, for example the case of output buffer 925 which may have no downstream buffer, the process returns to step 1105 without generating a material handling requirement. Where the result of conditional step 1130 is in the affirmative, the process advances to conditional step 1135 to determine whether the inventory volume of the selected buffer exceeds a predetermined volume threshold. For instance, if the selected output buffer is output buffer 930, and if output buffer 930 has an inventory volume that exceeds the predetermined volume threshold, then the result of conditional step 1135 would be in the affirmative, generating a material handling requirement in step 1145 for the transport of mail from output buffer 930 to downstream input buffer 940. Conditional step 1135 may be referred to as an upstream mail accumulation rule.

Where the result of conditional step 1135 is in the negative, the process advances to conditional step 1140 to determine whether any inventory of the selected output buffer has aged beyond a predetermined elapsed time threshold. Where the result of conditional step 1140 is in the affirmative, the process advances to step 1145 to generate a material handling requirement for the transport of mail from the selected output buffer to one or more downstream buffers. Where the result of conditional step 1140 is in the negative, the process returns to step 1105 without generating a material handling requirement. Step 1140 may be referred to as a mail waiting time rule.

Variations to the process depicted in FIG. 11 are possible. For example, the downstream threshold rule, upstream mail accumulation rule, and the mail waiting time rule may be used by themselves, or in any combination and sequence, according to design choice.

Advantageously, step 245 generates material handler requirements based at least in part on equipment scheduling parameters. Generation step 245 may also be performed in a stand-alone or offline mode, for example to investigate different rules for generating material handler requirements, or to investigate the effect of assigning material handlers with different processing rates to different operations.

Functional Architecture

FIG. 12 is a block diagram of a functional architecture for optimizing equipment and staffing schedules, according to one embodiment of the invention. As shown therein, an equipment scheduler 1205 provides inputs to a staff scheduler 1210. Staff scheduler 1210 consolidates inputs for processing by a staff scheduler solving engine 1215. Staff scheduler solving engine 1215 produces an optimized staff schedule 1220. Accordingly, staffing schedules are generated with the benefit of equipment scheduling information.

Equipment scheduler 1205 may provide one or more inputs to staff scheduler 1210. In one respect, equipment scheduler 1205 may provide information regarding equipment operating requirements resulting from the optimized equipment operating plan 1255. In another respect, equipment scheduler 1205 may provide material handler requirements 1260. In the illustrated embodiment, both types of requirements are input to the staff scheduler 1210. Moreover, feedback from the optimized staff schedules 1220 to the equipment scheduler 1205 provides a mechanism for further validating the optimized equipment operating plan 1255 based on the ability to satisfy projected staffing needs.

As shown in FIG. 12, the equipment scheduler 1205 includes a volume arrival profile 1225 (e.g., describing raw material or other material inputs by type, quantity, and date/time of availability) and material flow pattern and facility configuration 1230 (e.g., describing the capability and quantity of processing equipment in a factory or other processing facility), each providing input to an equipment scheduler graphical user interface (GUI) 1235. An equipment scheduler solving engine 1245 receives inputs via the equipment scheduler GUI 1235 and an optimization algorithm 1240 in order to generate the optimized equipment operating plan 1255. The equipment scheduler solving engine 1245 also interfaces to a simulation model 1250 for validation of the equipment scheduling solution.

In addition, the simulation model 1250 utilizes the equipment scheduling solution generated by the equipment scheduler solving engine 1245 to create a demand for material handlers, the demand being expressed in the form of material handler requirements 1260. The optimized equipment operating plan 1255 and the material handler requirements 1260 are functionally coupled to the staff scheduler 1210.

The equipment scheduler GUI 1235 allows for the input and editing, as desired, of the volume arrival profile 1225 and the material flow pattern and facility configuration 1230 to the equipment schedules solving engine 1245. The optimization algorithm 1240 provides the logic for the equipment scheduler-solving engine 1245.

The functional architecture may be hosted in a network-based environment, where, for example, the equipment scheduler solving engine 1245 and the staff scheduler solving engine 1215 are hosted on one or more network servers, and where the equipment scheduler GUI 1235 resides on a client on the network. In one embodiment, the network is the Internet, and the equipment scheduler GUI 1235 interfaces to the equipment scheduler solving engine 1245 via a Web portal.

The functional architecture illustrated in FIG. 12 can be configured to execute the processes described above. For example, the equipment scheduler 1205, staff scheduler 1210, staff scheduler solving engine 1215 and optimized staff schedules 1220 can be used interactively to execute the process described with reference to FIG. 2. In particular, the equipment scheduler GUI 1235 can implement process steps 210 and 215, the equipment scheduler solving engine 1245 can perform process steps 220, 235, and 240, the simulation model 1250 can perform steps 225, 230, 245 and 255, and the staff scheduler solving engine 1215 can execute step 250. Moreover, the equipment scheduler solving engine 1245 can be configured via hardware and/or software to implement any one of the processes described with reference to FIGS. 3-8. Further, simulation model 1250 can be configured to execute any of the processes described with reference to FIGS. 9-11. Any of the foregoing processes may be embodied in software, stored in a computer readable media, and executed by a processor.

Variations to the functional architecture illustrated in FIG. 12 are possible. For example, in one embodiment, the functionality of the equipment scheduler solving engine 1245 and the functionality of the simulation model 1250 are combined into a single component. It should also be appreciated that the equipment scheduler 1205 could operate independent of the staff scheduler 1210, staff scheduler solving engine 1215 and/or optimized staff schedules 1220. Moreover, in other embodiments, various components of the equipment scheduler, such as the equipment scheduler GUI 1235 may be optional.

### Summary

The invention described above thus overcomes the disadvantages of known systems and methods by considering staffing constraints in developing equipment schedules and by providing outputs from an equipment scheduling tool that can facilitate improved labor scheduling. The invention also has utility in evaluating the type and quantity of machines needed for a new processing facility. While this invention has been described in various explanatory embodiments, other embodiments and variations can be effected by a person of ordinary skill in the art without departing from the scope of the invention. For example, while embodiments of the invention are described with reference to a mail P&DC, the systems and methods are applicable to other forms of process equipment scheduling. Likewise, while the disclosure of systems and methods for generating material handler requirements may be especially suited for mail handlers, the same or equivalent systems and methods may be utilized for developing material handling requirements in other industries.

1. A method for planning, comprising:
generating an equipment scheduling solution for equipment used to process items, the generating the equipment scheduling solution including minimizing an amount of ending inventory of the items in a scheduling time period;
generating staffing requirements for personnel during the scheduling time period based on the equipment scheduling solution; and
generating a staffing solution for the scheduling time period based on the staffing requirements.

2. The method of claim 1, the generating the equipment scheduling solution further including minimizing a number of shifts that a piece of equipment is active during the scheduling time period.

3. The method of claim 1, the generating the equipment scheduling solution further including minimizing a number of process start-ups for a piece of equipment during the scheduling time period.

4. The method of claim 1, the generating the equipment scheduling solution further including minimizing a number of process start-ups early in the scheduling time period as compared to later in the scheduling time period for a piece of equipment during the scheduling time period.

5. The method of claim 1, further comprising validating the equipment scheduling solution based on a simulation of work in process.

6. The method of claim 5, the validating based on a comparison of work in process at the end of the scheduling time period for the equipment scheduling solution and the simulation.

7. A method for planning, comprising:
receiving equipment scheduling data and constraints for equipment used to process items;
creating a first equipment scheduling solution that minimizes inventory of the items remaining unprocessed at the end of a scheduling period;
relaxing an ending inventory by a first parameter, the relaxing the ending inventory raising an ending inventory constraint value for evaluating subsequent alternative equipment scheduling solutions; and
creating a second equipment scheduling solution based on the first equipment scheduling solution and the ending inventory constraint that minimizes a number of shifts that a piece of equipment is scheduled during the scheduling period.

8. The method of claim 7, further comprising:
relaxing a number of shifts by a second parameter, the relaxing the number of shifts raising a shift constraint value for evaluating subsequent alternative equipment scheduling solutions; and
creating a third equipment scheduling solution based on the second equipment scheduling solution and the shift constraint value that minimizes a number of process start-ups early in the scheduling period as compared to later in the scheduling period for a piece of equipment during the scheduling period.

9. The method of claim 7, further comprising pre-processing prior to the generating the first equipment scheduling solution that minimizes ending inventory, the pre-processing eliminating at least one possible equipment scheduling solution that is not optimal.

10. The method of claim 7, further comprising post-processing after the generating the second equipment scheduling solution, the post-processing converting the format of the second equipment scheduling solution from a startup time and a end time for an equipment type to the startup time and the end time for each of a plurality of pieces of equipment of the equipment type.

11. A method for generating material handler staffing requirements, comprising:
modeling a plurality of process operations, each of the plurality of process operations having an input buffer, a processing capability, and at least one output buffer;
calculating inventory for each of the plurality of process operations during a time period, the calculating including:
decrementing inventory in the associated input buffer; and
incrementing inventory in the associated at least one output buffer, the decrementing and incrementing based on the associated processing capability; and
determining material handler requirements based on inventory in at least one of the associated input buffer and the associated at least one output buffer at the end of the time period.

12. The method of claim 11, the modeling including linking one of the at least one output buffers of a first process operation to an input buffer of a second process operation.

13. The method of claim 11, the determining material handler requirements including:
selecting a buffer;
determining whether the selected buffer is an input buffer type or an output buffer type;
if the selected buffer is the input buffer type, determining whether an upstream buffer exists;
if the upstream buffer exists, determining whether the selected buffer is starving for inventory; and
if the selected buffer is starving for inventory, generating a material handler requirement for the transport of inventory from the upstream buffer to the selected buffer.

14. The method of claim 11, the determining material handler requirements including:
selecting a buffer;
determining whether the selected buffer is an input buffer type or an output buffer type;
if the selected buffer is the output buffer type, determining whether a downstream buffer exists;
if the downstream buffer exists, determining whether an inventory of the selected buffer is greater than a predetermined inventory threshold value; and
if the inventory of the selected buffer is greater than the predetermined inventory threshold value, generating a material handler requirement for transport of inventory from the selected buffer to the downstream buffer.

15. The method of claim 14, further including:
if the inventory of the selected buffer is not greater than the predetermined inventory threshold value, determining whether an elapsed time for inventory in the selected buffer exceeds a predetermined time threshold value; and
if the elapsed time for inventory in the selected buffer exceeds the predetermined time threshold value, generating the material handler requirement for transport of inventory from the selected buffer to the downstream buffer.

16. A machine-readable medium having instructions stored thereon for execution by a processor to perform a method comprising:
generating an equipment scheduling solution for equipment used to process items, the generating the equipment scheduling solution including minimizing an amount of ending inventory of the items in a scheduling time period;
generating staffing requirements for personnel during the scheduling time period based on the equipment scheduling solution; and
generating a staffing solution for the scheduling time period based on the staffing requirements.

17. A machine-readable medium having instructions stored thereon for execution by a processor to perform a method comprising:
receiving equipment scheduling data and constraints for equipment used to process items;
creating a first equipment scheduling solution that minimizes inventory of the items remaining unprocessed at the end of a scheduling period;
relaxing an ending inventory by a first parameter, the relaxing the ending inventory raising an ending inventory constraint value for evaluating subsequent alternative equipment scheduling solutions; and
creating a second equipment scheduling solution based on the first equipment scheduling solution and the ending inventory constraint that minimizes a number of shifts that a piece of equipment is scheduled during the scheduling period.

18. A machine-readable medium having instructions stored thereon for execution by a processor to perform a method comprising:
modeling a plurality of process operations, each of the plurality of process operations having an input buffer, a processing capability, and at least one output buffer;
calculating inventory for each of the plurality of process operations during a time period, the calculating including:
decrementing inventory in the associated input buffer; and
incrementing inventory in the associated at least one output buffer, the decrementing and incrementing based on the associated processing capability; and determining material handler requirements based on inventory in at least one of the associated input buffer and the associated at least one output buffer at the end of the time period.

19. A planning system comprising:
an equipment scheduling engine, the equipment scheduling engine configured to output an equipment scheduling solution based on a minimized ending inventory of items processed by the equipment;
a simulation model, the simulation model configured to validate the equipment scheduling solution and further configured to generate material handler requirements; and
an interface to a staff scheduler.

20. The planning system of claim 19, the equipment scheduling engine further configured to output the equipment scheduling solution based on minimizing a number of scheduled shifts in a piece of equipment during a predetermined time period.
